(19) United States
(12) Patent Application Publication
(10) Pub. No.: US 2025/0281881 A1
(43) Pub. Date: Sep. 11, 2025

(54) ELECTRODEIONIZATION DEVICE AND OPERATION METHOD THEREFOR

(71) Applicant: ORGANO CORPORATION, Tokyo (JP)

(72) Inventors: Mayu ABE, Tokyo (JP); Keisuke SASAKI, Tokyo (JP); Yuki NAKAMURA, Tokyo (JP)

(73) Assignee: ORGANO CORPORATION, Tokyo (JP)

(21) Appl. No.: 18/869,362

(22) PCT Filed: Apr. 17, 2023
(86) PCT No.: PCT/JP2023/015325

§ 371 Date: Nov. 26, 2024

(30) Foreign Application Priority Data
Jun. 1, 2022 (JP) 2022-089793

(51) Int. Cl. B01D 61/48; B01D 61/46; C02F 1/469; C02F 101/10

(52) U.S. Cl. CPC B01D 61/485; B01D 61/463; C02F 1/4695; B01D 2313/28; C02F 2101/108

(57) ABSTRACT

An electrodeionization device includes a deionization chamber partitioned by a pair of ion exchange membranes; and a concentration chamber disposed adjacent to the deionization chamber via the ion exchange membrane which is disposed on a side facing a cathode. When representing a particle size of 0.1 mm or more and 0.4 mm or less by small particle size; and a particle side exceeding 0.4 mm by large particle size, a large particle size layer consisting of an ion exchange resin of large particle size, and a mixed particle size layer in which ion exchange resins of large particle size and small particle size are mixed are arranged in the concentration chamber along a flow direction of water to be treated. At least a part of the ion exchange resin filled in the concentration chamber is a cation exchange resin.

### TECHNICAL FILED

The present invention relates to an electrodeionization device and an operation method therefor.

### BACKGROUND ART

A further reduction in boron content is required in ultrapure water used for manufacturing a semiconductor device or the like. However, boron in water is a weak acid component that is less likely to be removed in a general ion exchange process of passing water to be treated to an ion exchange resin. Therefore, it is attempted to use an electrodeionization device (EDI device) to remove boron in water to be treated. The EDI device is a device for generating deionized water from water to be treated by combining electrophoresis and electrodialysis, wherein at least deionization chamber thereof is filled with an ion exchange resin. The EDI device has the advantage of dispensing with a process of regenerating the ion exchange resin by chemicals. However, even in the EDI device, sufficient removal performance for a weak acid component such as boron can not be obtained only by simply filling the deionization chamber with an ordinary ion exchange resin.

The ordinary ion exchange resin has a bead-like or granular shape, and its typical particle size exceeds 0.4 mm and is about 1 mm or less. In order to improve the performance of removing a weak acid component in an EDI device, it is proposed to fill a deionization chamber with an ion exchange resin having a smaller particle size. For example, Patent Literature 1 discloses that an ion exchange resin having an average particle size of 150 to 250 μm is filled in a deionization chamber of an EDI device in a single bed manner. Patent Literature 2 discloses that an ion exchange resin having an average diameter of 0.2 to 0.3 mm is filled in a deionization chamber in a single bed manner. Patent Literatures 3 and 4 disclose that, in a deionization chamber in which water to be treated flows in the vertical direction, an ion exchange resin having an average particle size of 0.1 to 0.4 mm is filled in a middle region in the vertical direction, and an ion exchange resin having an average particle size exceeding 0.4 mm is filled in each of regions on the upper side and the lower side of the middle region.

It is important to control the packing ratio of the ion exchange resin in the deionization chamber in order to reduce electric resistance of the deionization chamber during the operation of the EDI device and improve the efficiency of deionization. Patent Literature 5 discloses that a group of ion exchange resins having a uniform particle size is referred to as an ion exchange resin particle group, and a plurality of ion exchange resin particle groups of different particle sizes are mixed and filled in the deionization chamber to reduce the electric resistance of the deionization chamber.

### CITATION LIST

### Patent Literature

Patent Literature 1: JP 2016-150304 A
Patent Literature 2: JP 2017-176968 A
Patent Literature 3: JP 2019-177327 A
Patent Literature 4: JP 2020-78772 A
Patent Literature 5: JP H10-258289 A

### SUMMARY OF INVENTION

### Technical Problem

Even if the removal performance of boron components in the EDI device is increased by filling the deionization chamber with an ion exchange resin having a small particle size, the removal performance of boron may be insufficient when the boron concentration is removed to the very small amount level. For example, when boron is removed from the water to be treated having a boron concentration of about 10 μg/L to obtain the treated water having a boron concentration at a ng/L level, there are cases where a single-stage EDI device may not sufficiently remove boron and two-stage EDI devices must be used in series.

The object of the present invention is to provide an EDI device with improved removal performance of boron and a method for operating the EDI device.

### Solution to Problem

An EDI device (electrodeionization device) according to the present is an EDI device equipped with: a deionization chamber arranged between an anode and a cathode, filled with an ion exchange resin, and partitioned by a pair of ion exchange membranes including a first ion exchange membrane disposed on a side to the anode and a second ion exchange membrane disposed on a side to the cathode; and a concentration chamber disposed adjacent to the deionization chamber via the second ion exchange membrane and filled with an ion exchange resin. The EDI device is characterized in that: a particle size of 0.1 mm or more and 0.4 mm or less is represented by small particle size, and a particle side exceeding 0.4 mm is represented by large particle size; in the deionization chamber, a large particle size layer comprising an ion exchange resin of large particle size and a mixed particle size layer in which an ion exchange resin of large particle size and an ion exchange resin of small particle size are mixed are arranged along a flow direction of water to be treated in the deionization chamber; at least a part of the ion exchange resin filled in the concentration chamber is a cation exchange resin; and the water to be treated that contains boron is supplied to the deionization chamber and boron is removed from the water to be treated.

The operation method according to present invention is characterized in that, in an operation method of the EDI device according to the present invention, the concentration of hardness components in the water to be treated supplied to the deionization chamber is set to 0.1 mg/L or less.

### Advantageous Effect of Invention

According to the present invention, it is possible to improve the removal performance of boron in an EDI device, thereby obtaining deionized water in which the boron concentration is reduced to an extremely small amount level.

### BRIEF DESCRIPTION OF DRAWINGS

FIG. 1 is a diagram showing an EDI device according to a first embodiment of the present invention;

FIG. 2 is a diagram illustrating a leak of boron components;

FIG. 3 is a diagram showing another example of the EDI device according to the first embodiment;

FIGS. 4A to 4E are diagram showing packing examples of an ion exchange resin in the deionization chamber;

FIG. 5 is a diagram showing an EDI device according to a second embodiment of the present invention;

FIG. 6 is a diagram showing another example of the EDT device according to the second embodiment;

FIG. 7 is a diagram showing another example of the EDI device according to the second embodiment;

FIG. 8 is a flow diagram showing a configuration of a pure water production system;

FIG. 9 is a diagram illustrating the EDI device used in Examples 1 and 2.

FIG. 10 is a diagram illustrating the EDI device used in Comparative Example 1;

FIG. 11 is a diagram illustrating the EDI device used in Comparative Example 2;

FIG. 12 is a diagram illustrating the EDI device used in Comparative Example 3;

FIG. 13 is a diagram illustrating the EDI device used in Comparative Examples 4 and 5; and

FIG. 14 is a diagram illustrating the EDI device used in Reference Examples 1 and 2.

### DESCRIPTION OF EMBODIMENTS

Next, embodiments of the present invention will be described with reference to the drawings. In general, in an electrodeionization device (EDI device), a deionization chamber partitioned by a pair of ion exchange membranes is provided between an anode and a cathode, and an ion exchange resin is filled in the deionization chamber. Then, when water to be treated is supplied to the deionization chamber in a state in which a DC voltage is applied between the anode and the cathode, the EDI device performs deionization (desalting) treatment on the water to be treated, and as a result, water from which the ion components have been removed is discharged from the deionization chamber as treated water. Among the ion components removed from the water to be treated in the deionization chamber, an anion component moves to a compartment adjacent to the deionization chamber via an ion exchange membrane provided on the anode side in the deionization chamber, and a cation component moves to another compartment adjacent to the deionization chamber via an ion exchange membrane provided on the cathode side in the deionization chamber. The compartment to which the ion component moves from the deionization chamber via the ion exchange membrane is a concentration chamber. Here, regarding the particle size of the ion exchange resin, the particle size of 0.1 mm or more and 0.4 mm or less is defined as a small particle size, and the particle size exceeding 0.4 mm is defined as large particle size.

In the EDI device according to the present invention, in order to increase the removing efficiency of boron in the water to be treated, a large particle size layer consisting of an ion exchange resin having large particle size and a mixed particle size layer in which an ion exchange resin having large particle size and an ion exchange resin having small particle size are mixed are disposed in the deionization chamber in the flow direction of the water to be treated in the deionization chamber. Since the particle size of the ion exchange resin having a bead-like or granular shape is usually 1 mm or less, an ion exchange resin having a particle size of more than 0.4 mm and 1 mm or less may be used as the ion exchange resin having large particle size. Although the particle size of the ion exchange resin can be measured using a sieve, a value in a catalog prepared by a manufacturer of ion exchange resins may be used as the particle size in the present invention. In the EDI device according to the present invention, an anion exchange resin (AER) having large particle size and an anion exchange resin having small particle size may be mixed to form a mixed particle size layer of anion exchange resin, and a cation exchange resin (CER) having large particle size and a cation exchange resin having small particle size may be mixed to form a mixed particle size layer of cation exchange resin.

Here, a mixing ratio of an ion exchange resin having large particle size and an ion exchange resin having small particle size in the mixed particle size layer will be described. Since the shape of the ion exchange resin is bead-like or granular regardless of whether it is large particle size or small particle size, the apparent volume including the voids between the particles can be measured. Therefore, representing the apparent volume of the ion exchange resin having large particle size before mixing by L and the apparent volume of the ion exchange resin having small particle size by S, the mixing ratio L:S is considered. The mixing ratio L:S is preferably between 1:3 and 10:1, more preferably between 1:1 and 5:1. Since sufficient removal performance for a weak acid component such as boron is not obtained when the proportion of the ion exchange resin having large particle size is too high, in order to achieve sufficient removal performance for boron, it seems necessary that L:S=10:1 or the proportion of the ion exchange resin having large particle size is smaller than that in the case of L:S=10:1. On the other hand, when the proportion of the ion exchange resin having small particle size is too high, an increase in the differential pressure of water passing may be caused.

The mixing ratio L:S between the ion exchange resin of large particle size and the ion exchange resin of small particle size can be determined even after the formation of the mixed particle size layer by mixing of the ion exchange resin of large particle size and the ion exchange resin of small particle size. For example, the mixing ratio L:S can be obtained by taking out the mixed particle size layer from the deionization chamber, classifying the mixed particle size layer using a sieve to separate an ion exchange resin having a particle size of 0.1 mm or more and 0.4 mm or less and an ion exchange resin having a particle size exceeding 0.4 mm, and measuring the apparent volume of each separated ion exchange resin.

Further, in the EDI device according to the present invention, an ion exchange resin is also filled in the concentration chamber, and at least a part of the ion exchange resin filled in the concentration chamber is a cation exchange resin. The cation exchange resin may be filled alone in the concentration chamber. However, since the applied voltage to the EDI device is likely to rise when the water to be treated or water supplied to the concentration chamber contains a hardness component such as calcium or magnesium at, for example, 0.05 to 0.1 mg/L, it is preferable that an anion exchange resin and an cation exchange resin are mixed and filled in the concentration chamber. Representing the apparent volume of the anion exchange resin by A and the apparent volume of the cation exchange resin by C when the anion exchange resin and the cation exchange resin are mixed and filled in the entire concentration chamber, the mixing ratio A:C of these ion exchange resins is preferably between 20:80 and 60:40, and more preferably from 20:80 to 50:50. Even after the anion exchange resin and the cation exchange resin are mixed and filled in the concentration chamber, the mixing ratio A:C of the anion exchange resin and the cation exchange resin can be obtained in the same manner as described above.

Furthermore, the ion exchange resin having large particle size may be filled alone in the concentration chamber. In order to suppress an increase in the applied voltage caused by arranging the cation exchange resin in the concentration chamber, it is preferable to reduce the concentration of the hardness component in the water to be treated supplied to the deionization chamber to 0.1 mg/L or less by, for example, arranging a reverse osmosis membrane device in the preceding stage of the EDI device as described later. The concentration of the hardness component is determined by converting the amount of calcium and magnesium into the amount of calcium carbonate (CaCO₃), and the calculation formula is represented by the following formula.

$$Hardness [ mg / L ] ( amount of calcium [ mg / L ] \times 2.5 ) + ( amount of magnesium [ mg / L ] \times 4.1 )$$

### First Embodiment

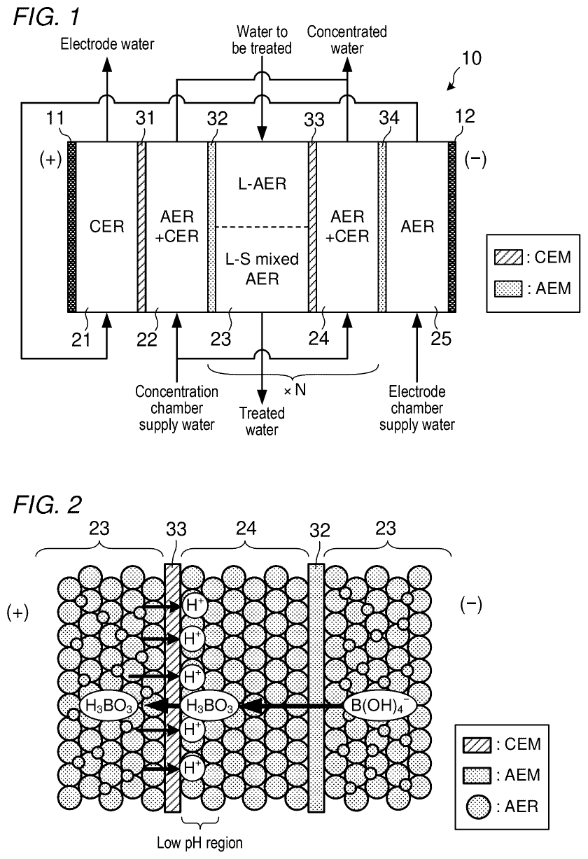

FIG. 1 illustrates EDI device 10 according to a first embodiment of the present invention. In this EDI device 10, between anode chamber 21 provided with anode 11 and cathode chamber 25 provided with cathode 12, concentration chamber 22, deionization chamber 23 and concentration chamber 24 are provided in this order from the side of anode chamber 21. Anode chamber 21 and concentration chamber 22 are adjacent to each other across cation exchange membrane (CEM) 31, concentration chamber 22 and deionization chamber 23 are adjacent to each other across anion exchange membrane (AEM) 32, deionization chamber 23 and concentration chamber 24 are adjacent to each other across cation exchange membrane 33, and concentration chamber 24 and cathode chamber 25 are adjacent to each other across anion exchange membrane 34. Anode chamber 21 and cathode chamber 25 may be collectively referred to as an electrode chamber. In this configuration, deionization chamber 23 is partitioned by a pair of ion exchange membranes (here, anion exchange membrane 32 and cation exchange membrane 33) between anode 11 and cathode 12. Deionization chamber 23 is filled with an ion exchange resin, and supplied with water to be treated. Treated water (deionized water) obtained as a result of performing deionization treatment on the water to be treated flows out from deionization chamber 23. In the example shown here, deionization chamber 23 is filled with an anion exchange resin.

The inside of deionization chamber 23 is divided into two regions toward the flow direction of the water to be treated in deionization chamber 23, an anion exchange resin of large particle size is filled in a region on the inlet side of the water to be treated to form a large particle size layer, and an anion exchange resin of large particle size and an anion exchange resin of small particle size are mixed and filled in a region on the outlet side of the treated water to form a mixed particle size layer. In the figure, the large particle size layer made of the anion exchange resin is described as “L-AER,” and the mixed particle size layer made of the anion exchange resin is described as “L-S mixed AER.” In the illustrated example, the boundary between the large particle size layer and the mixed particle size layer is approximately near the center of deionization chamber 23 toward the flow direction of the water to be treated.

Further, in EDI device 10, a cation exchange resin is filled in anode chamber 21, and an anion exchange resin is filled in cathode chamber 25. As described in “AER+CER” in the figure, the anion exchange resin and the cation exchange resin are mixed and filled in concentration chambers 22, 24, that is, in a mixed bed form. Although anode chamber 21 and cathode chamber 25 do not necessarily have to be filled with an ion exchange resin, it is preferable to fill anode chamber 21 and cathode chamber 25 with an ion exchange resin in order to lower the DC voltage to be applied between anode 11 and cathode 12 during the operation of EDI device 10. Concentration chambers 22, 24 are supplied with concentration chamber supply water and discharge concentrated water. Electrode chamber supply water is supplied to cathode chamber 25, and electrode chamber supply water supplied to cathode chamber 25 is supplied to anode chamber 21 after passing through cathode chamber 25, and is discharged from anode chamber 21 as electrode water. Noted that a structure serving as both a concentration chamber and an electrode chamber can be possible.

In general, in EDI devices, a plurality of basic configurations each consisting of [concentration chamber/ion exchange membrane/deionization chamber/ion exchange membrane/concentration chamber] can be juxtaposed between the anode and the cathode via ion exchange membranes. At this time, the two adjacent concentration chambers across an ion exchange membrane can be treated as a single concentration chamber by removing the sandwiched ion exchange membrane. In EDI device 10 shown in FIG. 1, assuming that anion exchange membrane 32, deionization chamber 23, cation exchange membrane 33, and concentration chamber 24 form one basic configuration, N basic configurations can be arranged between concentration chamber 22 closest to anode chamber 21 and anion exchange membrane 34 in contact with cathode chamber 25. N is an integer of 1 or more. The notation of “×N” in the figure indicates that a plurality of basic configurations can be arranged side by side.

Next, the production of deionized water (treated water) by EDI device 10 shown in FIG. 1 will be described. Similarly to the case of a general EDI device, the water to be treated is made flow through deionization chamber 23 under the condition in which the concentration chamber supply water is passed through concentration chambers 22, 24, the electrode chamber supply water is supplied to cathode chamber 25, the electrode chamber supply water discharged from cathode chamber 25 is also passed through anode chamber 21, and a DC voltage is applied between anode 11 and cathode 12. Then, ion components in the water to be treated are adsorbed by the ion exchange resin in deionization chamber 23, moved inside the deionization chamber by the action of the electric current, and discharged to the adjacent concentration chamber. Thus, the deionization (desalting) progresses, and the deionized water flows out as the treated water from deionization chamber 23. The water to be treated first passes through the large particle size layer in deionization chamber 23, where strong acid components, and weak acid components that are relatively easily adsorbed by the anion exchange resin are removed from the water to be treated. After that, components contained in the water to be treated such as boron that are relatively difficult to remove are removed from the water to be treated by being adsorbed on the anion exchange resin when passing through the mixed particle size layer that contains the anion exchange resin with small particle size. As a result, the treated water in which the weak acid components such as boron is sufficiently removed is discharged from deionization chamber 23. Although the water passing resistance is larger in the mixed particle size layer than the large particle size layer, the increase in the differential pressure of water passing can be within the allowable range by controlling the packing ratio or the like in deionization chamber 23, as apparent from Examples or the like described later.

In deionization chamber 23 of EDI device 10 of the present embodiment, the large particle size layer and the mixed particle size layer may be provided one by one, or at least one of the large particle size layer and the mixed particle size layer may be provided in two or more layers. However, in order to improve the removal efficiency, the configuration is preferable in which components that are relatively easily removed in the water to be treated are initially removed and then the components that are relatively difficult to remove are removed. Therefore, in EDI device 10 of the present embodiment, at least one large particle size layer is present on the upstream side of the mixed particle size layer even when attention is paid to any of the mixed particle size layers. That is, the large particle size layer and the mixed particle size layer are arranged such that, in deionization chamber 23, the water to be treated first passes through the large particle size layer before passing through the mixed particle size layer. It is preferable to arrange the mixed particle size layer at a position close to the outlet of the treated water in deionization chamber 23. In this case, the mixed particle size layer may be disposed so as to be in contact with the outlet of the treated water, or at least a part of the mixed particle size layer may be included in a range of 25% of the length of deionization chamber 23 along the flow of the water to be treated from the outlet of the treated water.

Both the mixed particle size layer and the large particle size layer are disposed in deionization chamber 23, and it is preferable that the ratio of the mixed particle size layer among them is such that, for example, a total packing height of the ion exchange resin along the flow of the water to be treated in the mixed particle size layer is 20% or more and 80% or less of a length of deionization chamber 23 along the flow of the water to be treated. If the proportion of the mixed particle size layer is too small, the removal performance of weak acid components including boron is reduced. Since the ion exchange resin of small particle size is generally expensive compared to the ion exchange resin of large particle size, the influence on the cost cannot be ignored when the proportion of the mixed particle size layer is too large. In this Description, the packing height of the ion exchange resin along the flow of the water to be treated in the large particle size layer or the mixed particle size layer may be referred to as a packing height of that layer. The length of deionization chamber 23 refers to the length of deionization chamber 23 along the flow of the water to be treated and the length of the portion where the ion exchange resin is arranged in deionization chamber 23.

The weak acid component such as boron in the water to be treated is adsorbed on the anion exchange resin constituting the mixed particle size layer by ion exchange, and then passes through anion exchange membrane 32 as an anion and moves to concentration chamber 22 on the side to anode 11. In concentration chamber 22, it is preferable that the anion concentration in the water flowing through the position facing the mixed particle size layer of deionization chamber 23 with anion exchange membrane 32 therebetween is low. As described above, it is preferable that the mixed particle size layer is provided at a position close to the outlet in deionization chamber 23. Therefore, it is preferable that the flow of the outlet water in deionization chamber 23 and the flow of the concentration chamber supply water supplied to concentration chamber 22 are countercurrent.

Next, by describing a phenomenon in which a leak of the boron component from deionization chamber 23 occurs, improvement of the removal rate of boron in EDI device 10 of the present embodiment will be described. FIG. 2 is a diagram illustrating a leak of a boron component from deionization chamber 23. Here, deionization chamber 23 and concentration chamber 24 are alternately disposed between anode 11 and cathode 12, the ion exchange resin having large particle size and the ion exchange resin having small particle size are mixed and filled in deionization chamber 23, and the anion exchange resin is filled in concentration chamber 24 in a single bed form.

The boron component in the water to be treated is captured by the anion exchange resin as a boron-containing anion in deionization chamber 23 on the right side of the figure, and moves to concentration chamber 24 on the side to anode 11 via anion exchange membrane 32. If the boron component is boric acid (H₃BO₃), boric acid dissociates as shown in the following formula in water.

H₃BO₃+H₂O→H⁺+B(OH)₄⁻

Since boric acid is dissociated in this manner, the boron-containing anion is B(OH)₄⁻. As a result of the boron-containing anion moving to concentration chamber 24, the boron-containing anion is captured in the anion exchange resin in concentration chamber 24. By the electric field generated by the applied DC voltage, the boron-containing anion moves to the vicinity of cation exchange membrane 33 in concentration chamber 24, but since the boron-containing anion is an anion, the boron-containing anion cannot permeate cation exchange membrane 33. Therefore, in concentration chamber 24, the boron-containing anion is concentrated in the vicinity of cation exchange membrane 33 located on the side to anode 11. Further, due to the applied DC voltage, hydrogen ions (H⁺) are moved from deionization chamber 23 on the side to anode 11 to concentration chamber 24 via cation exchange membrane 33. As a result, the pH of the region near cation exchange membrane 33 in concentration chamber 24 is lowered. This region is a region in which the boron-containing anion is concentrated, water and a boric acid molecule, for example, are generated from the boron-containing anion due to hydrogen ions, and a water layer containing boric acid at a high concentration is formed near cation exchange membrane 33 in concentration chamber 24. Since boric acid, which is a neutral molecule, can move through cation exchange membrane 33, the boric acid moves from concentration chamber 24 to deionization chamber 23 through cation exchange membrane 33. The boron component removed from the water to be treated in deionization chamber 23 is dissolved again in the water to be treated in deionization chamber 23 located closer to anode 11 than initial deionization chamber 23, and the boron component leaks to the treated water discharged from deionization chamber 23.

In order to prevent such a leakage of the boron component, it is conceivable to prevent a region in which the pH is lowered from being formed in the vicinity of cation exchange membrane 33 in concentration chamber 24. To do so, it is effective to quickly move hydrogen ions which have moved to concentration chamber 24 via cation exchange membrane 33 to the side to cathode 12 in concentration chamber 24. Therefore, in EDI device 10 according to the present invention, a cation exchange resin is present in concentration chamber 24.

If the boron component is allowed to be included in the electrode water discharged from anode chamber 21, the cation exchange resin does not necessarily have to be filled in concentration chamber 22 adjacent to anode chamber 21. Concentration chamber 22 adjacent to anode chamber 21 is a concentration chamber in which no deionization chamber 23 is present between this concentration chamber and anode chamber 21. Further, since the boron component shifts mainly from the mixed particle size layer in deionization chamber 23 to concentration chamber 24 through anion exchange membrane 32, it is considered that, in concentration chamber 24, the cation exchange resin may be present only in a region facing the region in which the mixed particle size layer is formed in deionization chamber 23, with anion exchange membrane 32 interposed therebetween.

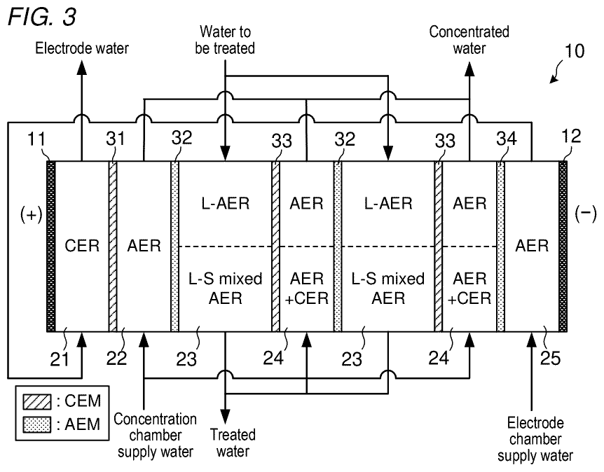

FIG. 3 illustrates another example of EDI device 10 according to the first embodiment. EDI device 10 shown in FIG. 3 is EDI device 10 shown in FIG. 1 in which N=2, that is, an EDI device provided with two sets of basic configurations. In EDI device 10 shown in FIG. 3, only the anion exchange resin is filled in concentration chamber 22 adjacent to anode chamber 21, and the other concentration chambers 24 are divided into a region in which only the anion exchange resin is filled and a region in which the cation exchange resin and the anion exchange resin are mixed and filled. Concentration chamber 24 is a concentration chamber adjacent to deionization chamber 23 via cation exchange membrane 33 on the side to cathode 12 of deionization chamber 23. The region where the cation exchange resin and the anion exchange resin are mixed and filled in concentration chamber 24 is a region adjacent to, with cation exchange membrane 33 sandwiched therebetween, the region in which the mixed particle size layer is formed in deionization chamber 23, that is, a region to which the boron-containing anion moves from deionization chamber 23 on the side closer to cathode 12 via anion exchange membrane 32. In addition, the region in which only the anion exchange resin is filled in concentration chamber 24 faces the region in which the large particle size layer is formed in deionization chamber 23 with cation exchange membrane 33 interposed therebetween. In EDI device 10 shown in FIG. 3, since the cation exchange resin is present, in concentration chamber 24, at the region where the boron-containing anion moves from deionization chamber 23 located on the side to cathode 12 in concentration chamber 24, the leakage of the boron component to deionization chamber 23 existing on the side to anode 11 with respect to that concentration chamber 24 can be prevented.

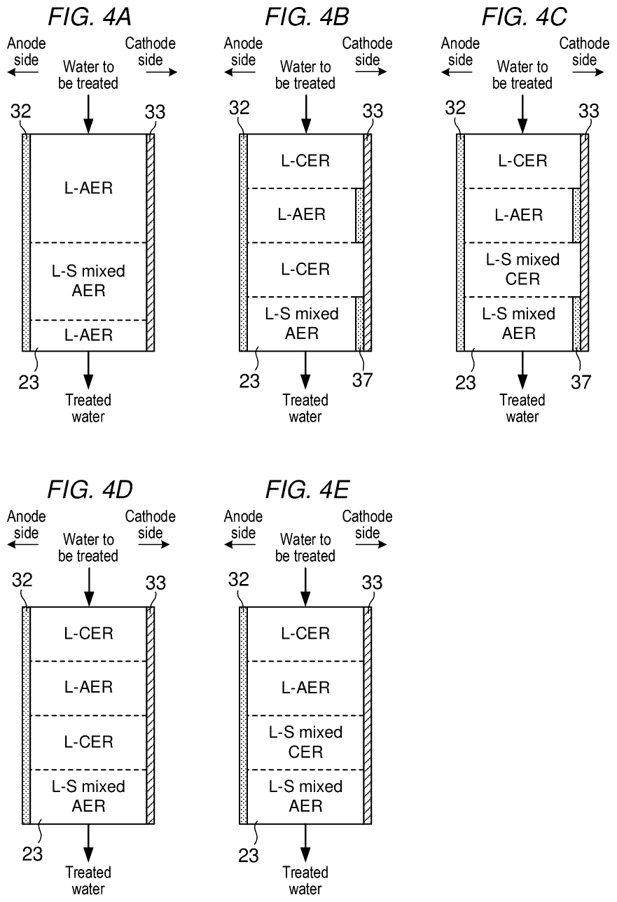

In EDI devices 10 shown in FIGS. 1 and 3, a large particle size layer made of an anion exchange resin is disposed on the inlet side in deionization chamber 23, and a mixed particle size layer made of an anion exchange resin is disposed on the outlet side in deionization chamber 23. As is clear from the above description, the arrangement of the ion exchange resins in deionization chamber 23 is not limited to those shown in FIGS. 1 and 3. FIGS. 4A to 4E illustrate other examples of the arrangement of the ion exchange resins in deionization chamber 23 by drawing out only deionization chamber 23 and the ion exchange membranes on both sides thereof. FIG. 4A shows that, in deionization chamber 23 in EDI device 10 shown in FIG. 1, a large particle size layer with a small packing height is arranged in contact with the outlet of deionization chamber 23 and a mixed particle size layer is disposed between a large particle size layer on the inlet side of deionization chamber 23 and the large particle size layer on the outlet side. In the example shown in FIG. 4A, the packing height of the mixed particle size layer is about 36% of the length of deionization chamber 23, and the packing height of the large particle size layer on the outlet side is about 14% of the length of deionization chamber 23.

In order to remove ionic impurities that are cations, not only the anion exchange resin but also the cation exchange resin (CER) may be filled in deionization chamber 23. In the example shown in FIG. 4B, a large particle size layer consisting of a cation exchange resin, a large particle size layer comprising an anion exchange resin, a large particle size layer consisting of a cation exchange resin, and a mixed particle size layer consisting of an anion exchange resin are arranged in this order in deionization chamber 23. The packing height of each layer is substantially the same. In the figure, the large particle size layer made of the cation exchange resin is described as “L-CER.” In deionization chamber 23 shown in FIG. 4B, in order to promote the dissociation reaction of water on side to cathode 12 of the anion exchange resin, anion exchange membrane 37 is disposed on an interface at which cation exchange membrane 33 and the anion exchange resin in deionization chamber 23 contact with each other.

Deionization chamber 23 shown in FIG. 4B is configured that, in deionization chamber 23 shown in FIG. 4B, the large particle size layer on the outlet side among two large particle size layer made of the anion exchange resin is replaced with a mixed particle size layer made of a cationic resin. In the figure, the mixed particle size layer consisting of the cation exchange resin is described as “L-S mixed CER.” Anion exchange membrane 37 provided in contact with cation exchange membrane 33 does not necessarily have to be provided.

The configurations shown in FIGS. 4D and 4E are obtained by removing anion exchange membrane 37 from the configurations shown in FIGS. 4B and 4C, respectively, and the anion exchange resin in deionization chamber 23 is in contact with cation exchange membrane 33 on the side to cathode 12 thereof. In EDI device 10 according to the present invention, either the anion exchange resin or the cation exchange resin may be used for the mixed particle size layer. However, in the case of removing boron, at least one of a large particle size layer of an anion exchange resin and a mixed particle size layer of an anion exchange resin are preferably provided in deionization chamber 23, and it is particularly preferable to provide a mixed particle size layer consisting of an anion exchange resin.

### Second Embodiment

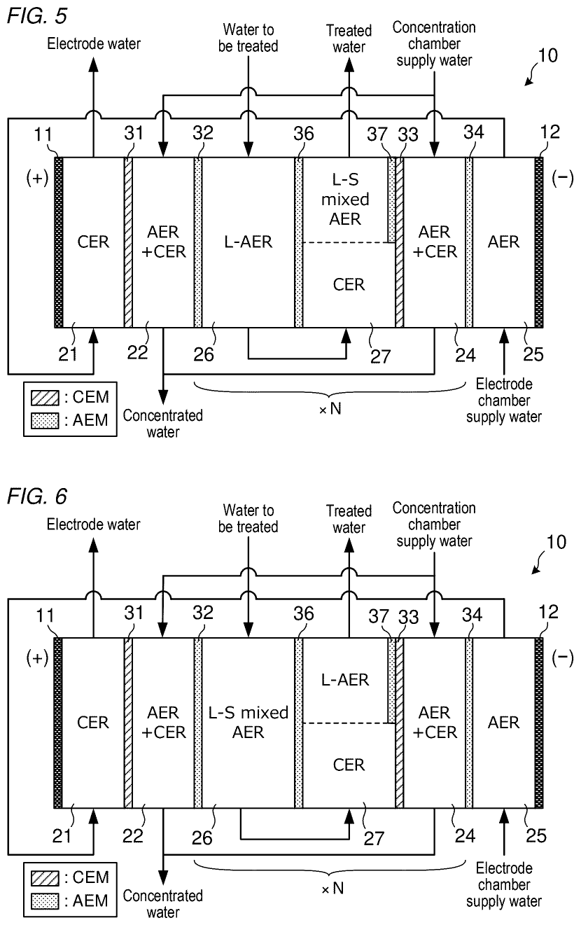

In the EDI device according to the present invention, the deionization chamber itself can be partitioned into two small deionization chambers by an ion exchange membrane so that water to be treated is supplied to one small deionization chamber, and water flowing out from the one small deionization chamber can be supplied to the other small deionization chamber. Deionized water is obtained as treated water from the other small deionization chamber. In EDI device 10 according to the second embodiment shown in FIG. 5, deionization chamber 23 in EDI device 10 shown in FIG. 1 is partitioned into two small deionization chambers 26, 27 by anion exchange membrane 36 that is an intermediate ion exchange membrane, and the arrangement of the ion exchange resin in the deionization chamber is made different. The small deionization chamber disposed on the side close to anode 11 across anion exchange membrane 36 is first small deionization chamber 26, and the small deionization chamber disposed on the side close to cathode 12 is second small deionization chamber 27. The water to be treated is supplied to first small deionization chamber 26, and the outlet water from first small deionization chamber 26 is supplied to second small deionization chamber 27. The outlet water from second small deionization chamber 27 is treated water (deionized water) from EDI device 10. When the deionization chamber is partitioned into first small deionization chamber 26 on the inlet side and second small deionization chamber 27 on the outlet side, the length of the deionization chamber means the sum of the length of the portion where the ion exchange resin is provided in first small deionization chamber 26 and the length of the portion where the ion exchange resin is provided in second small deionization chamber 27 along the flow of the water to be treated.

In EDI device 10 shown in FIG. 5, the direction of the flow in first small deionization chamber 26 and the direction of the flow in second small deionization chamber 27 are opposite to each other, that is, countercurrent. The direction of the flow in concentration chamber 22 on the side to anode 11 is the same as the direction of the flow of first small deionization chamber 26 adjacent thereto, and both are in a parallel flow relationship. The direction of the flow in second small deionization chamber 27, which is the outlet side as the deionization chamber, and the direction of the flow in concentration chamber 24 adjacent thereto are in a countercurrent relationship. First small deionization chamber 26 is filled with an anion exchange resin as a large particle size layer. In second small deionization chamber 27, the inlet side is filled with a cation exchange resin, and the outlet side is filled with an anion exchange resin as a mixed particle size layer. The cation exchange resin is usually provided as a large particle size layer, but may be a mixed particle size layer. The position of the boundary between the mixed particle size layer of the anion exchange resin and the cation exchange resin in second small deionization chamber 27 is approximately half of the length of second small deionization chamber 27, in other words, the position that is about 25% of the length of the deionization chamber by measuring from the outlet side of the deionization chamber. Anion exchange membrane 37 is provided at an interface at which cation exchange membrane 33 and the anion exchange resin in second small deionization chamber 27 contact with each other. The anion exchange resin in second small deionization chamber 27 may be in direct contact with cation exchange membrane 33 without providing anion exchange membrane 37. In EDI device 10 shown in FIG. 5, since the water to be treated passes through the mixed particle size layer of the anion exchange resin, the weak acid component such as boron can be efficiently removed.

In the second embodiment in which the deionization chamber is divided into two small deionization chambers by the intermediate ion exchange membrane, a preferable mixing ratio of the ion exchange resin of large particle size and the ion exchange resin of small particle size in the mixed particle size layer and a preferred ratio of the total sum of the packing heights of the mixed particle size layer to the length of the deionization chamber are the same as those described in the first embodiment. In the second embodiment, it is preferable that the mixed particle size layer is provided at a position close to the outlet of the treated water as a whole deionization chamber, and at least a part of the mixed particle size layer may be included within a range of 25% of the length of the deionization chamber from the outlet of the treated water.

FIG. 6 illustrates another configuration example of the EDI device according to the second embodiment. EDI device 10 shown in FIG. 6 is configured such that, in EDI device 10 shown in FIG. 5, the anion exchange resin filled in first small deionization chamber 26 is provided as a mixed particle size layer, and instead, the anion exchange resin filled in second small deionization chamber 27 is provided as a large particle size layer.

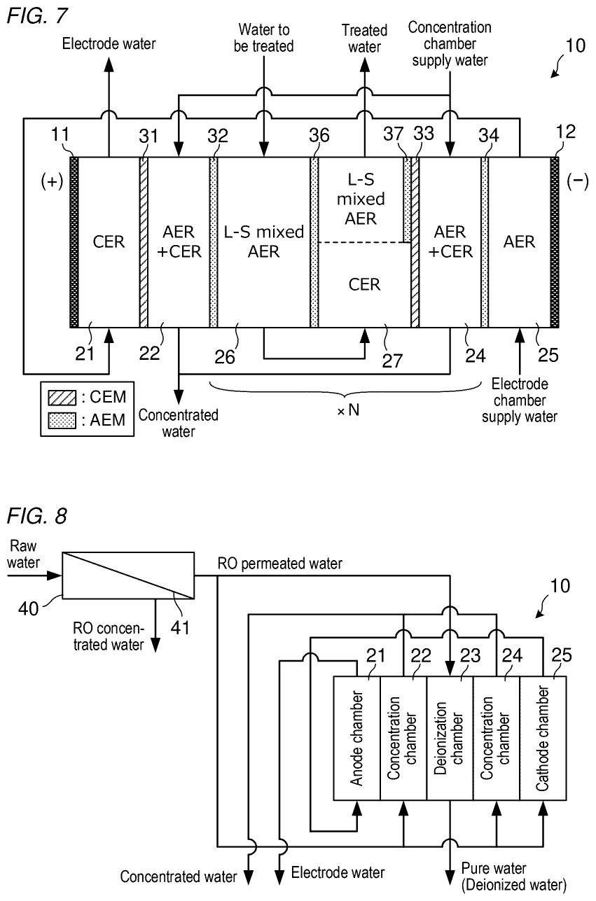

FIG. 7 illustrates yet another configuration example of the EDI device according to the second embodiment. EDI device 10 shown in FIG. 7 is configured such that, in EDI device 10 shown in FIG. 5, the anion exchange resin filled in first small deionization chamber 26 is provided as a mixed particle size layer. In this EDI device 10, the anion exchange resin filled in second small deionization chamber 27 is provided as a large particle size layer.

The EDI device according to the present invention has been described above. The EDI device can be used, for example, when pure water or ultrapure water is produced from raw water. FIG. 8 is a flow diagram illustrating a configuration of a pure water production system using EDI device 10 described above. In this figure, the electrodes and each ion exchange membrane are not drawn. Although this drawing is depicted as using EDI device 10 in the first embodiment, it is also possible to use EDI device 10 in the second embodiment. A reverse osmosis membrane device (RO) to which the raw water is supplied is provided, and reverse osmosis membrane 41 is provided inside reverse osmosis membrane device 40. Water (RO concentrated water) that has not passed through reverse osmosis membrane 41 in reverse osmosis membrane device 40 contains many impurities, and the RO concentrated water is blown to the outside. Water (RO permeated water) that has passed through reverse osmosis membrane 41 in reverse osmosis membrane device 40 is water relatively free of impurities, and is supplied to deionization chamber 23 of EDI device 10 as the water to be treated. A part of the RO permeated water is supplied to concentration chambers 22, 24 and cathode chamber 25 as the concentration chamber supply water and the electrode chamber supply water. Alternatively, in order to prevent influence of diffusion of boron from concentration chambers 22, 24, a part of the deionized water discharged from deionization chamber 23 may be supplied to concentration chambers 22, 24 and cathode chamber 25 as the concentration chamber supply water and the electrode chamber supply water, or pure water or ultrapure water supplied from the outside of the system may be supplied to concentration chambers 22, 24 and cathode chamber 25. The electrode water discharged from anode chamber 21 is blown to the outside, and the concentrated water discharged from concentration chambers 22, 24 is also blown to the outside.

A DC voltage is applied between an anode (not shown in FIG. 8) provided in anode chamber 21 and a cathode (not shown in FIG. 8) provided in cathode chamber 25, and the RO permeated water is supplied to deionization chamber 23 as the water to be treated, so that deionization treatment is performed in deionization chamber 23, and pure water is extracted from deionization chamber 23 as treated water (deionized water). The weak acid component, in particular boron, contained in the raw water easily permeates reverse osmosis membrane 41 to be contained in the RO permeated water. When the EDI device is provided at the subsequent stage of the reverse osmosis membrane device to remove boron or the like, since the conventional EDI device is not sufficient in the removal performance of boron, EDI devices might be in two stages. However, by using EDI device 10 of each embodiment described above, boron in the water to be treated can be sufficiently removed only by providing one-stage EDI device 10 in the subsequent stage of reverse osmosis membrane device 40. In addition, as will be apparent from Examples and Comparative Examples described later, the differential pressure of water passing in the deionization chamber can be reduced in the EDI device according to the present invention, and as reverse osmosis membrane device 40, a reverse osmosis membrane device that has a small operating pressure, that is, an ultra-low pressure reverse osmosis membrane device, and a super ultra-low pressure reverse osmosis membrane device can be used.

As described above, according to the EDI device according to the present invention, the mixed particle size layer in which an ion exchange resin having large particle size and an ion exchange resin having small particle size are mixed is arranged in the deionization chamber, and at least a part of the ion exchange resin filled in the concentration chamber is a cation exchange resin, whereby the removal rate of boron component can be improved, and pure water and ultrapure water of higher water quality can be obtained. Improving the removal rate of boron component in the EDI device leads to miniaturization of, for example, a reverse osmosis membrane device provided in a preceding stage of the EDI device, and miniaturization of, for example, an ion exchange device provided in a subsequent stage of the EDI device.

### EXAMPLES

Next, the present invention will be further described in detail by Examples, Reference Examples, and Comparative Examples. In the following description, the mixing ratio when an ion exchange resin having large particle size and an ion exchange resin having small particle size are mixed to form a mixed particle size layer is represented by L:S. L is the apparent volume of the ion exchange resin of large particle size before mixing, and S is the apparent volume of the ion exchange resin of small particle size before mixing. In the following Examples and Comparative Examples, a gel-type strongly basic anion exchange resin of a styrene-based matrix which has a particle size range of 0.50 to 0.65 mm was used as the anion exchange resin (AER) of large particle size, and a gel-type strong basic anion exchange resin of a styrene-based matrix which has a particle size range of 0.28 to 0.34 mm was used as the anion exchange resin of small particle size. As the cation exchange resin (CER), a gel-type strong acid cation exchange resin of a styrene-based matrix which has a particle size range of 0.60 to 0.70 mm was used. This cation exchange resin is a cation exchange resin having large particle size.

### Example 1

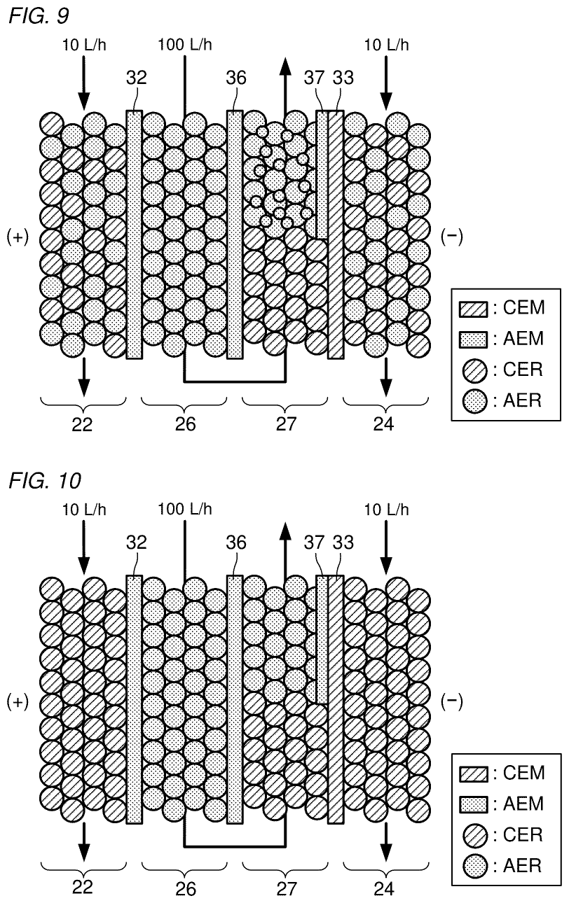

EDI device 10 shown in FIG. 5 was assembled. FIG. 9 shows a configuration of a main part of EDI device 10 used in Example 1. For each of concentration chambers 22, 24 and small deionization chambers 26, 27, a cell (frame body) having an opening with a size of 150 mm×300 mm and a thickness of 10 mm was used. EDI device 10 was assembled by filling the cell of each chamber with the ion exchange resin and stacking these cells in the thickness direction of the cell across the ion exchange membranes. In the mixed particle size layer provided in second deionization chamber 27, the anion exchange resin of large particle size and the anion exchange resin of small particle size were mixed and filled so that L:S was 5:1. Concentration chambers 22, 24 were filled with mixture of the anion exchange resin of large particle size and the cation exchange resin of large particle size. Water to be treated having a boron concentration of 10 μg/L was sequentially passed through small deionization chambers 26, 27 at 100 L/h, supply water was passed through each of concentration chambers 22, 24 at 10 L/h. EDI device 10 was operated by applying a DC voltage between anode 11 and cathode 12 so that the current density was 1.1 A/dm². After 2500 hours from the start of operation, the boron concentration in the treated water was measured to calculate the boron removal rate. The results are shown in Table 1.

### Example 2

Except that the mixing ratio L:S between the anion exchange resin of large particle size and the anion exchange resin of small particle size in the mixed particle size layer was 1:1, EDI device 10 similar to that in Example 1 was assembled, and EDI device 10 was operated in the same manner as in Example 1. The boron removal rate at the time where 2500 hours elapsed from the start of operation was determined. The results are shown in Table 1.

### Comparative Example 1

EDI device 10 was assembled such that, in EDI device 10 of Example 1, concentration chambers 22, 24 were filled with only the cation exchange resin of large particle size instead of mixing and filling the cation exchange resin and the anion exchange resin, a large particle size layer consisting of only the anion ion exchange of large particle size was provided instead of the mixed particle size layer of second small deionization chamber 27. FIG. 10 shows a configuration of a main part of EDI device 10 used in Comparative Example 1. In the same manner as in Example 1, EDI device 10 was operated to obtain a boron removal rate at a point of time where 2500 hours elapsed from the start of the operation. The results are shown in Table 1.

### Comparative Example 2

EDI device 10 was assembled such that, in EDI device 10 of Comparative Example 1, the anion exchange resin of large particle size and the cation exchange resin of large particle size were mixed and filled in concentration chambers 22, 24 instead of solely filling the concentration chambers with the cation ion exchange resin. FIG. 11 shows a configuration of a main part of EDI device 10 used in Comparative Example 2. In the same manner as in Example 1, EDI device 10 was operated to obtain a boron removal rate at a point of time where 2500 hours elapsed from the start of the operation. The results are shown in Table 1.

### Comparative Example 3

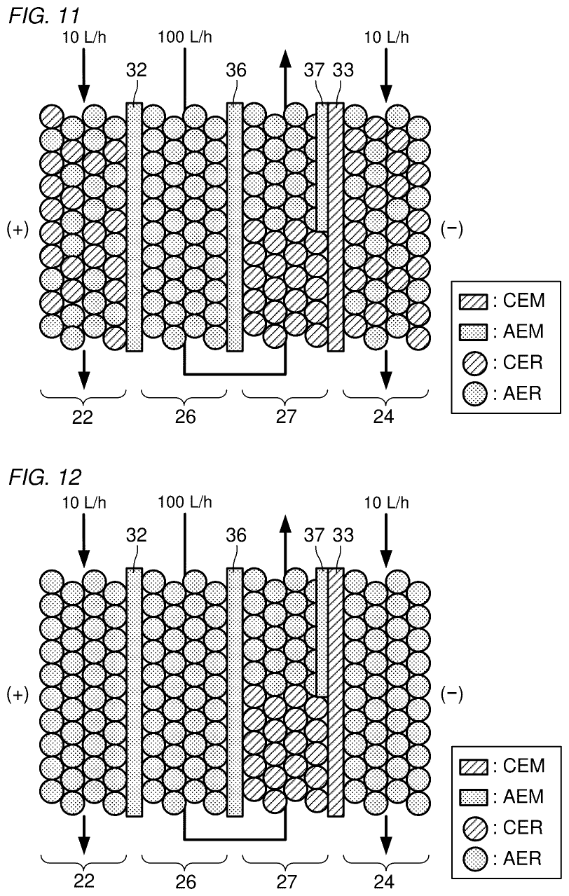

EDI device 10 was assembled such that, in EDI device 10 of Comparative Example 1, concentration chambers 22, 24 were filled with only the anion exchange resin of large particle size instead of filling the concentration chambers with only the cation exchange resin. FIG. 12 shows a configuration of a main part of EDI device 10 used in Comparative Example 3. In the same manner as in Example 1, EDI device 10 was operated to obtain a boron removal rate at a point of time when 2500 hours elapsed from the start of the operation. The results are shown in Table 1.

### Comparative Example 4

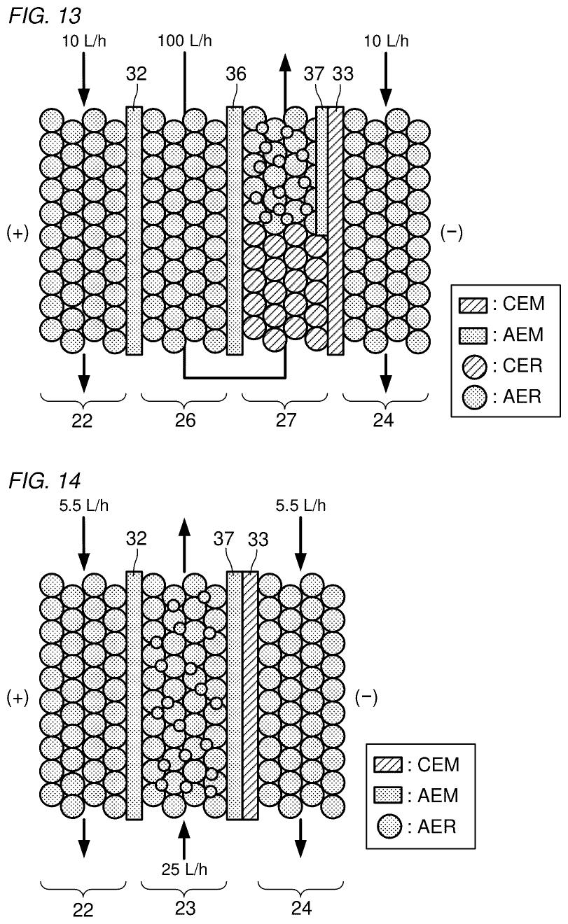

EDI device 10 was assembled such that, in EDI device 10 of Example 1, concentration chambers 22, 24 were filled with only the anion exchange resin of large particle size instead of mixing and filling the cation exchange resin and the anion exchange resin. The mixing ratio L:S between the anion exchange resin of large particle size and the anion exchange resin of small particle size in the mixed particle size layer of this EDI device was 5:1. FIG. 13 shows a configuration of a main part of EDI device 10 used in Comparative Example 4. In the same manner as in Example 1, EDI device 10 was operated to obtain a boron removal rate at a point of time when 2500 hours elapsed from the start of the operation. The results are shown in Table 1.

### Comparative Example 5

EDI device 10 similar to Comparative Example 1 was assembled except that the mixing ratio L:S of the anion exchange resin of large particle size and the anion exchange resin of small particle size in the mixed particle size layer was 1:1. EDI device 10 was operated in the same manner as in Example 1, and the boron removal rate at the time where 2500 hours elapsed from the start of operation was obtained. The results are shown in Table 1.

TABLE 1

| | Configuration of | Layer on outlet side | Mixing | |
|---|---|---|---|---|
| | concentration | of second small | ratio | Removal rate |
| | chamber | deionization chamber | L:S | of boron [%] |
| Example 1 | AER + CER | Mixed particle size layer | 5:1 | 99.96 |
| Example 2 | AER + CER | Mixed particle size layer | 1:1 | 99.96 |
| Comparative Example 1 | CER | Large particle size layer | — | 99.95 |
| Comparative Example 2 | AER + CER | Large particle size layer | — | 99.88 |
| Comparative Example 3 | AER | Large particle size layer | — | 99.44 |
| Comparative Example 4 | AER | Mixed particle size layer | 5:1 | 99.42 |
| Comparative Example 5 | AER | Mixed particle size layer | 1:1 | 99.23 |

In the EDI devices of Examples 1 and 2, which are EDI devices according to the present invention, the boron removal rate after the 2500 hours operation was 99.96%, and a high boron removal rate was exhibited. Therefore, it was found that the boron concentration in the treated water can be reduced to, for example, less than 10 ng/L only by providing one stage of the EDI device according to the present invention.

On the other hand, in Comparative Examples 1 to 3 in which an anion exchange resin of large particle size and an anion exchange resin of small particle size were not mixed to be filled in the deionization chamber, the removal rate of boron was reduced as compared with Examples 1 and 2. Comparing in Comparative Examples 1 to 3, Comparative Example 1 in which only the cation exchange resin was filled in the concentration chamber shows the highest boron removal rate, but when the hardness component is included in the water to be treated or the concentration chamber supply water, there is a risk of an increase in the applied voltage. Although not shown in Table 1, in comparison with Examples 1 and 2, a phenomenon in which the differential pressure of water passing increases as the operation time becomes longer was recognized in Comparative Examples 1 and 2. On the other hand, in Comparative Example 3 in which only the anion exchange resin was filled in the concentration chamber, the boron removal rate was low as compared with Comparative Examples 1 and 2. Even if an anion exchange resin of large particle size and an anion exchange resin of small particle size were mixed and filled in the deionization chamber, the boron removal rate was not improved when only the anion exchange resin was filled in the concentration chamber as shown in Comparative Examples 4 and 5. Therefore, in order to improve the boron removal rate, it was found that an anion exchange resin having large particle size and an anion exchange resin having small particle size should be mixed and filled in least a part of the deionization chamber, and at least a part of the ion exchange resin filled in the concentration chamber should be a cation exchange resin. In this case, it was also found that the concentration chamber is preferably filled with an anion exchange resin and a cation exchange resin which are mixed.

### Reference Example 1

An increase in differential pressure of water passing caused by mixing and filling an anion exchange resin having large particle size and an anion exchange resin having small particle size in the deionization chamber was examined. EDI device 10 was assembled such that, in EDI device 10 shown in FIG. 1, only the anion exchange resin of large particle size was filled in concentration chambers 22, 24, and a mixed particle size layer in which an anion exchange resin of large particle size and an anion exchange resin of small particle size were mixed was arranged in the entire area of deionization chamber 23. Further, as the ion exchange membrane for partitioning deionization chamber 23 on the side to cathode 12, one in which anion exchange membrane 37 and cation exchange membrane 33 were overlapped so that anion exchange membrane 37 was disposed on the side to deionization chamber 23 was used.

FIG. 14 shows a configuration of a main part of EDI device 10 used in Reference Example 1. For each of concentration chambers 22, 24 and deionization chamber 23, a cell (frame body) having an opening with a size of 100 mm×100 mm and a thickness of 10 mm was used. The cells of each chamber was filled with an ion exchange resin, and these cells were stacked in the thickness direction of the cell across the ion exchange membranes to assemble EDI device 10. In the mixed particle size layer provided in deionization chamber 23, the anion exchange resin of large particle size having a particle size of 0.6 to 0.7 mm and the anion exchange resin of small particle size having a particle size of 0.3 mm were mixed and filled so that L:S was 1:1. Concentration chambers 22, 24 were filled with an anion exchange resin of large particle size having a particle size of 0.6 to 0.7 mm. At this time, the packing ratio of the anion exchange resin in deionization chamber 23 was 1.1. The packing ratio is a value obtained by applying a DC voltage between anode 11 and cathode 12 and passing water through deionization chamber 23 filled with the ion exchange resin to bring the ion exchange resin into a regenerated state, and then dividing the apparent volume in the free state of the ion exchange resin taken out from deionization chamber 23 by the volume of deionization chamber 23. The free state refers to a state in which the ion exchange resin is not constrained in a space such as a deionization chamber and a concentration chamber.

EDI device 10 was operated by passing the water to be treated having a boron concentration of 100 μg/L through deionization chamber 23 at 25 L/h, passing the supply water through concentration chambers 22, 24 at 5.5 L/h in, and applying a DC voltage between anode 11 and cathode 12 so that current density became 1.1 A/dm². In the same manner as in Example 1, the boron removal rate and the differential pressure of water passing at the time when 2500 hours elapsed from the start of operation were obtained. The results are shown in Table 2.

### Reference Example 2

EDI device 10 was assembled in the same manner as Reference Example 1 except that the packing ratio of the anion exchange resin in deionization chamber 23 was 1.2. EDI device 10 was operated similarly to Reference Example 1, and the boron removal rate and the differential pressure of water passing at the time when 2500 hours elapsed from the start of the operation were obtained. The results are shown in Table 2.

TABLE 2

| | Packing ratio of | | Differential |
|---|---|---|---|
| | anion exchange | | pressure |
| | resin in | Removal rate | of water |
| | deionization chamber | of boron [%] | passing [MPa] |
| Reference | 1.1 | 99.6 | 0.072 |
| Example 1 | | | |
| Reference | 1.2 | 98.8 | 0.076 |
| Example 2 | | | |

From the results of Reference Examples 1 and 2, even when the ratio L:S of the anion exchange resin of large particle size and the anion exchange resin of a small particle size was 1:1 in which the proportion of the anion exchange resin of the small particle size was considerably large, the difference pressure of water passing was small. No significant difference in the differential pressure of water passing was observed within a range of 1.1 to 1.2 in the packing ratio as the anion exchange resin. Thus, according to the EDI device based on the present invention, it was found that the differential pressure of water passing can be sufficiently reduced. Even in the case where the mixing ratio L:S was set to 1:3 in Reference Examples 1 and 2, increase in the differential pressure of water flow was not observed.

### REFERENCE SIGNS LIST

10 EDI device;
11 Anode;
12 Cathode;
13 Anode chamber;
22, 24 Concentration chamber;
23 Deionization chamber;
25 Cathode chamber;
26, 27 Small deionization chamber;
31, 33 Cation exchange membrane (CEM);
32, 34, 36, 37 Anion exchange membrane (AEM);
40 Reverse osmosis membrane device; and
41 Reverse osmosis membrane.

1. An electrodeionization device comprising: a deionization chamber arranged between an anode and a cathode, filled with an ion exchange resin, and partitioned by a pair of ion exchange membranes including a first ion exchange membrane disposed on a side to the anode and a second ion exchange membrane disposed on a side to the cathode; and a concentration chamber disposed adjacent to the deionization chamber via the second ion exchange membrane and filled with an ion exchange resin,
wherein when representing a particle size of 0.1 mm or more and 0.4 mm or less by small particle size and a particle side exceeding 0.4 mm by large particle size, in the deionization chamber, a large particle size layer comprising an ion exchange resin of large particle size, and a mixed particle size layer in which an ion exchange resin of large particle size and an ion exchange resin of small particle size are mixed are arranged along a flow direction of water to be treated in the deionization chamber,
wherein at least a part of the ion exchange resin filled in the concentration chamber is a cation exchange resin, and
wherein the water to be treated that contains boron is supplied to the deionization chamber and boron is removed from the water to be treated.

2. The electrodeionization device according to claim 1, wherein the ion exchange resin filled in the concentration chamber is an ion exchange resin of large particle size.

3. The electrodeionization device according to claim 1, wherein the concentration chamber is filled with an anion exchange resin and a cation exchange resin in a mixed state.

4. The electrodeionization device according to claim 3, wherein, when representing an apparent volume of the anion exchange resin A and an apparent volume of the cation exchange resin by C, a mixing ratio A:C of the anion exchange resin and the cation exchange resin in the concentration chamber is within a range of 20:80 to 60:40.

5. The electrodeionization device according to claim 1, wherein the mixed particle size layer and the large particle size layer are arranged so that at least one large particle size layer is present on a upstream side of the mixed particle size layer in the deionization chamber.

6. The electrodeionization device according to claim 1, wherein the deionization chamber is provided with the mixed particle size layer consisting of an anion exchange resin.

7. The electrodeionization device according to claim 6, wherein when representing an apparent volume of an anion exchange resin of large particle size by L and an apparent volume of an anion exchange resin of small particle size by S, an anion exchange resin of large particle size and an ion exchange resin of small particle diameter are mixed at a mixing ratio in which L:S is within a range of 1:3 to 10:1, in the mixed particle size layer.

8. The electrodeionization device according to claim 1, wherein the deionization chamber is provided with an intermediate ion exchange membrane located between the pair of ion exchange membranes and is partitioned into a first small deionization chamber and a second small deionization chamber by the intermediate ion exchange membrane, and the first small deionization chamber and the second small deionization chamber communicate with each other such that the water to be treated is supplied to one small deionization chamber of the first small deionization chamber and the second small deionization chamber, and water flowing out from the one small deionization chamber flows into the other small deionization chamber.

9. The electrodeionization device according to claim 8, wherein an anion exchange resin is filled in a small deionization chamber on a side close to the anode among the first small deionization chamber and the second small deionization chamber, and, in a small deionization chamber on a side close to the cathode, a cation exchange resin of large particle size is filled and the mixed particle size layer consisting of an anion exchange resin is disposed in the small deionization chamber on the side close to the cathode.

10. A method of operating the electrodeionization device according to claim 1, wherein a concentration of hardness components in the water to be treated supplied to the deionization chamber is set to 0.1 mg/L or less.
